(19) United States
(12) Patent Application Publication
(10) Pub. No.: US 2014/0092739 A1
(43) Pub. Date: Apr. 3, 2014

(54) FLOW FILTER MAPPING SCHEME WITH PCC FLOW-DIRECTION AVP

(71) Applicants: Xue Xiong, Ontario (CA); Kugendran Sabaratnam, Ontario (CA); Shanawaz Shaik, Ontario (CA)

(72) Inventors: Xue Xiong, Ontario (CA); Kugendran Sabaratnam, Ontario (CA); Shanawaz Shaik, Ontario (CA)

(73) Assignee: ALCATEL-LUCENT CANADA INC.

(21) Appl. No.: 13/630,624

(22) Filed: Sep. 28, 2012

(51) Int. Cl. H04W 24/00

(52) U.S. Cl. 370/235

(57) ABSTRACT

Various exemplary embodiments relate to a method performed by a policy and charging rules node (PCRN) device for implementing a PCC procedure with SDF inputs, the method including: receiving a PCC request with a SDF input; determining if the PCC request is from a user equipment (UE); mapping flow direction information from the SDF input request into a unified flow-direction record stored in the PCRN; generating PCC, ADC, and/or QoS rules based upon the unified flow-direction record; determining if flow direction is defined on an output interface; mapping the unified flow-direction record into a flow-information AVP associated with the generated PCC, ADC, and/or QoS rules.

### TECHNICAL FIELD

Various exemplary embodiments disclosed herein relate generally to telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks, leading to a less-than-elegant solution. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a policy and charging rules node (PCRN) device for implementing a PCC procedure with SDF inputs, the method including: receiving a PCC request with a SDF input; determining if the PCC request is from a user equipment (UE); mapping flow direction information from the SDF input request into a unified flow-direction record stored in the PCRN; generating PCC, ADC, and/or QoS rules based upon the unified flow-direction record; determining if flow direction is defined on an output interface; mapping the unified flow-direction record into a flow-information AVP associated with the generated PCC, ADC, and/or QoS rules; delivering the generated PCC, ADC, and/or QoS rules to another node.

Various exemplary embodiments relate to a method performed by a policy and charging rules node (PCRN) device for implementing a PCC procedure with SDF inputs, the method including: receiving a PCC request with a SDF input; determining if the PCC request is from a application function (AF); copying the flow information from the AF request directly to unified flow-direction records; generating PCC, ADC, and/or QoS rules based upon the unified flow-direction record; determining if flow direction is defined on an output interface; mapping the unified flow-direction record into a flow-information AVP associated with the generated PCC, ADC, and/or QoS rules; delivering the generated PCC, ADC, and/or QoS rules to another node.

Various exemplary embodiments relate to a method performed by a policy and charging rules node (PCRN) device for implementing a PCC procedure with SDF inputs, the method including: receiving a PCC request with a SDF input; determining if the PCC request is the result of the PCRN provisioning PCC, ADC, and/or QoS rules; determining if received flow information from the PCRN provisioning is bidirectional: if so, then mapping flow direction information from the PCRN request into unified flow-direction records stored in the PCRN; and if not, then copying the flow information from the PCRN request directly to unified flow-direction records; generating PCC, ADC, and/or QoS rules based upon the unified flow-direction record; determining if flow direction is defined on an output interface; mapping the unified flow-direction record into a flow-information AVP associated with the generated PCC, ADC, and/or QoS rules; delivering the generated PCC, ADC, and/or QoS rules to another node.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates a method for a PCC procedure with an SDF input;

FIG. 3 illustrates a Diameter RAR message on a Gx interface using the 3GPP TS 29.212 version 9.3.0 specification; and

FIG. 4 illustrates a Diameter RAR message on a Gx interface using the 3GPP TS2 9.212 version 8 specifications.

To facilitate understanding, identical reference numerals have been used to designate elements having substantially the same or similar structure and/or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Further, as used herein, the term “sync” will be understood to be synonymous with the term “synchronization.”

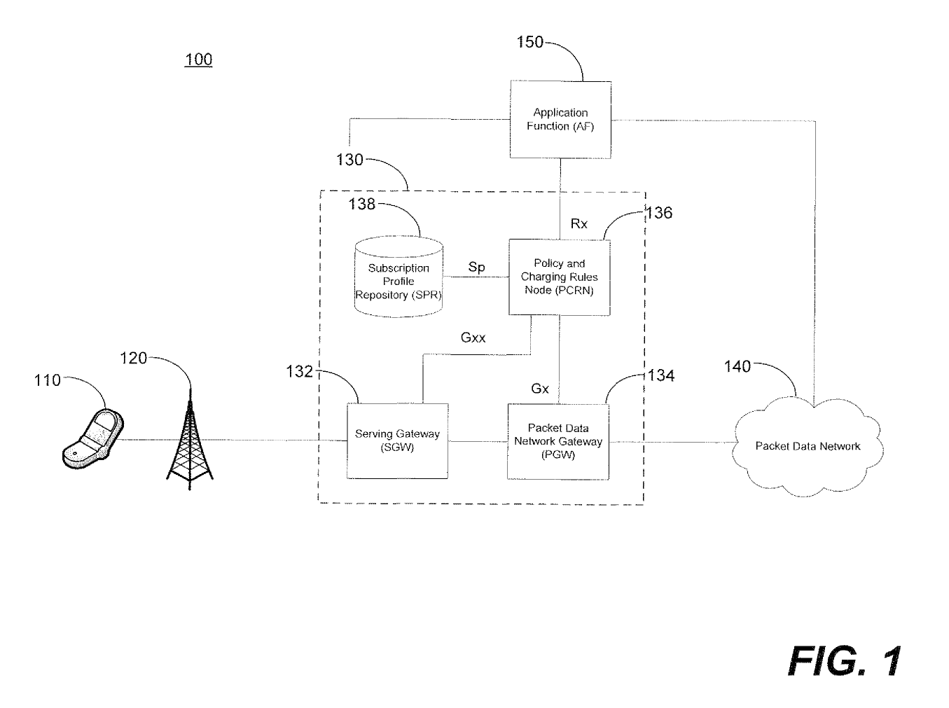

FIG. 1 illustrates an exemplary subscriber network 100 for providing various data services. Exemplary subscriber network 100 may be telecommunications network or other network for providing access to various services. Exemplary subscriber network 100 may include user equipment 110, base station 120, evolved packet core (EPC) 130, packet data network 140, and application function (AF) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136, and a subscription profile repository (SPR) 138.

Serving gateway (SGW) 132 may be a device that provides gateway access to the EPC 130. SGW 132 may be the first device within the EPC 130 that receives packets sent by user equipment 110. SOW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (POW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Policy and charging rules node (PCRN) 136 may be a device or group of devices that receives requests for application services, generates PCC rules, and provides PCC rules to the PGW 134 and/or other PCENs (not shown). PCRN 136 may be in communication with AF 150 via an Rx interface. As described in further detail below with respect to AF 150, PCRN 136 may receive an application request in the form of an Authentication and Authorization Request (AAR) 160 from AF 150. Upon receipt of AAR 160, PCRN 136 may generate at least one new PCC rule for fulfilling the application request 160.

PCRN 136 may also be in communication with SGW 132 and PGW 134 via a Gxx and a Gx interface, respectively. PCRN 136 may receive an application request in the form of a credit control request (CCR) (not shown) from SGW 132 or PGW 134. As with AAR 160, upon receipt of a CCR, PCRN may generate at least one new PCC rule for fulfilling the application request 170. In various embodiments, AAR 160 and the CCR may represent two independent application requests to be processed separately, while in other embodiments, AAR 160 and the CCR may carry information regarding a single application request and PCRN 136 may create at least one PCC rule based on the combination of AAR 160 and the CCR. In various embodiments, PCRN 136 may be capable of handling both single-message and paired-message application requests.

Upon creating a new PCC rule or upon request by the PGW 134, PORN 136 may provide a PCC rule to PGW 134 via the Gx interface. In various embodiments, such as those implementing the PMIP standard for example, PORN 136 may also generate QoS rules. Upon creating a new QoS rule or upon request by the SGW 132, PORN 136 may provide a QoS, rule to SGW 132 via the Gxx interface.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as bandwidth limits, charging parameters, and subscriber priority.

Packet data network 140 may be any network for providing data communications between user equipment 110 and other devices connected to packet data network 140, such as AF 150. Packet data network 140 may further provide, for example, phone and/or Internet service to various user devices in communication with packet data network 140.

Application function (AF) 150 may be a device that provides a known application service to user equipment 110. Thus, AF 150 may be a server or other device that provides, for example, a video streaming or voice communication service to user equipment 110. AF 150 may further be in communication with the PCRN 136 of the EPC 130 via an Rx interface. When AF 150 is to begin providing known application service to user equipment 110, AF 150 may generate an application request message, such as an authentication and authorization request (AAR) 160 according to the Diameter protocol, to notify the PCRN 136 that resources should be allocated for the application service. This application request message may include information such as an identification of the subscriber using the application service, an IP address of the subscriber, an APN for an associated IP-CAN session, and/or an identification of the particular service data flows that must be established in order to provide the requested service. AF 150 may communicate such an application request to the PCRN 136 via the Rx interface.

Although not shown in FIG. 1, the subscriber network 100 may also include a traffic detection function (TDF), for example, a deep packet inspection function. The PCRN 136 and the TDF may communicate using an Sd interface. In order to control the TDF, the PCRN 136 may generate application detection and control (ADC) rules to specify the types of traffic detection needed by the PCRN 136.

During a PCC procedure, associated packet filter or flow information may be provided by a UE request on a Gx or Gxx interface, or an AF request on an Rx interface, or from a PCRN internally provisioned PCC, ADC, or QoS rules based on a subscriber profile. By nature, any service data flow or flow filter has a direction attribute, however, this direction attribute is not explicitly presented in the 3GPP Gx specification document TS29.212 before version 9.2.0. A Flow-Direction attribute value pair (AVP) was defined in a Flow-Information AVP for PCC, ADC, and QoS rules in version 9.2.0, and the Flow-Direction AVP was later defined in a TFT-Packet-Filter-Information AVP and a Packet-Filter-Information AVP for a UE-request.

Further, for an AF requested PCC procedure on an Rx interface, flow information may be received as an input. Currently, a Flow-Direction AVP is not used on the Rx interface for an AF request. In view of the foregoing complications as a result of the differences in specifying flow direction and in order to achieve interworking among different PCC nodes which may support different versions of the 3GPP standards, a unified format flow information scheme with a flow direction attribute is described below.

In order to facilitate various PCC rule scenarios, the PCRN may store all flow-direction information in unified flow-direction records describing a unidirectional flow. In the case, where a bidirectional flow is described, information for each direction may be stored in the separate flow-direction records in the PCRN, that is, one AVP for uplink and one AVP for downlink. This allows for the data structure and code for handling the flow-direction information for the packet filter or flow information to be the same for various PCC rule scenarios. The following is a description of how various PCC rule scenarios may be handled by the PCRN.

For example, when a service data flow is described by a pair of flow-descriptions in a media-sub-component AVP in an AF request, the pair of flow-descriptions in the AF request may be mapped into two separate unified flow description records with flow direction attributes in the PCRN. The PCRN may then produce a PCC, ADC, or QoS rule that uses a bidirectional flow-direction AVP to describe the flow information presented in the AF request, if the version of the Gx or Gxx interface used to communicate the PCC, ADC, or QoS rule supports a bidirectional flow-direction AVP. If not, then two separate flow-description AVPs may be used to describe the bidirectional flow: one for uplink and one for down link.

When a PCC, ADC, or QoS rule request with SDF filter information is received from a UE via a PCEF, the flow-direction may be described using a bidirectional flow-direction AVP if supported. (that is, when the PCEF supports a newer version of 3GPP Gx specifications). In this case, the information from the bidirectional flow-direction AVP may be mapped into two separate unified flow description records with flow direction attributes in the PCRN. As described above, this allows for a unified flow information storage format in the PCRN. The PCRN may then produce PCC, ADC, or QoS rules that uses a bidirectional flow-direction AVP just as described above with respect to the AF request case.

If the a service data flow is described by a pair of flow-descriptions in an UE request without the Flow-Direction AVP (that is, when a PCEF supports legacy version of 3GPP Gx specifications), then the pair of flow-descriptions in the UE request may be mapped into two separate unified flow-direction records with flow direction attributes in the PCRN like in the AF request case described above. Further, the PCRN may then produce PCC, ADC, or QoS rules just as described above with respect to the AF request case.

There are scenarios where the PCRN may desire to provision PCC, ADC, or QoS rules. In this situation the PCRN may set up one or two PCRN unified flow-direction records to describe the SDF filter, depending on whether the flow is unidirectional or bidirectional. The PCRN may then produce PCC, ADC, or QoS rules just as described above with respect to the AF request case.

As illustrated in the examples above, the PCRN may store input packet filter or flow information internally in unified flow-direction records. Unidirectional flow filters may use one unified flow-direction record. Bidirectional flow filters may use two unified flow-direction records. This allows for accommodating any type of SDF request that the PCRN may receive. The unified flow-direction records may then be used to specify PCC, ADC, or QoS rules as described above. This makes it possible for common software to perform core functions for the PCC procedure with SDF input.

While the current implementation of the Rx interface used to communicate between an AF and the PCRN does not support a Flow-Direction AVP to describe flow information, in the future the Rx interface may be modified to include such a description. If this happens then, the PCRN may handle a bidirectional AF request on the Rx interface in the same manner as a bidirectional UE request is handled on the Gx interface.

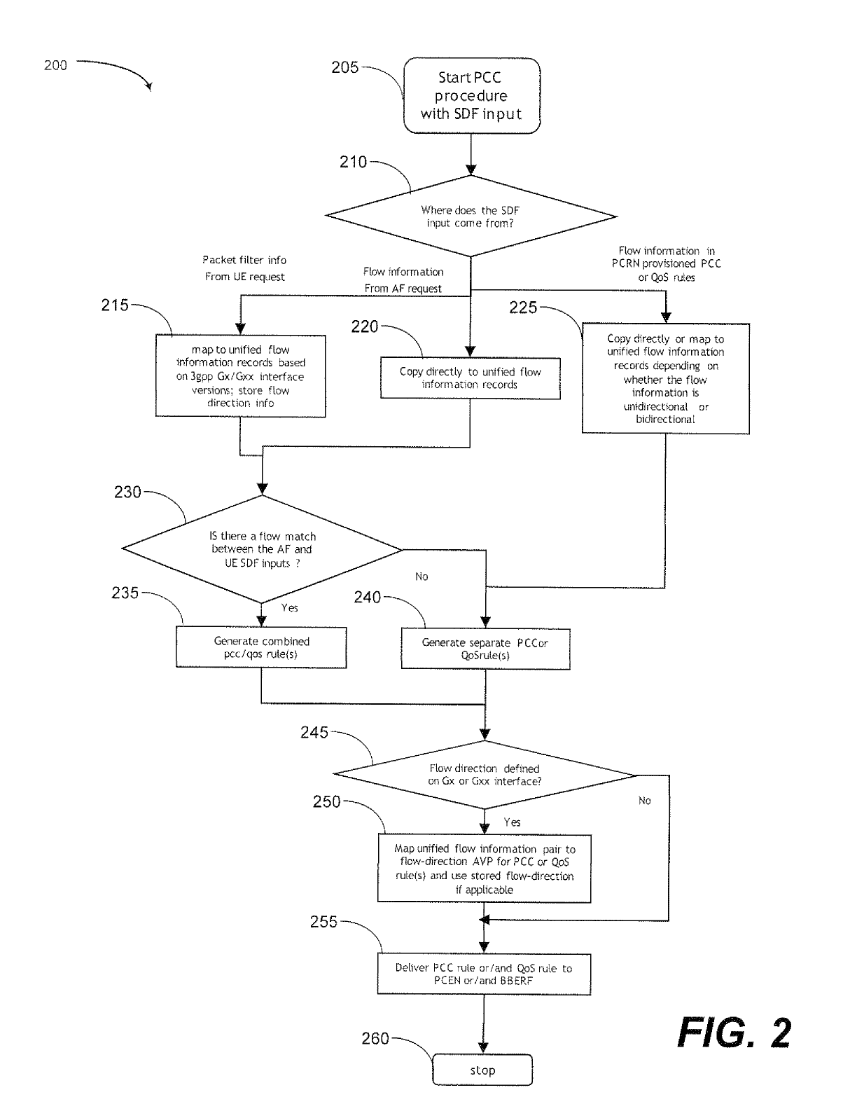

FIG. 2 illustrates a method for performing a PCC procedure with SDF input. The method 200 may start at 205 when the method 200 may receive a SDF input that may include packet filter or flow information. As discussed above, the SDF input may be received from an AF or UE. Further, a SDF input request may also be internally generated by the PCRN. This SDF input may be used to implement either PCC, ADC, or QoS rules. The information in the SDF input may be determined by the 3GPP version used on the interface. Further, the SDF input may or may not include a flow-direction AVP. Next, the method 200 may determine where the SDF input comes from 210.

If the SDF input is packet filter information from a UE request, then the method proceeds to map unified flow-direction records based upon the 3GPP Gx/Gxx interface version 215. Further, flow direction information may be stored if applicable. So if the 3GPP Gx/Gxx interface only specifies unidirectional filters, then those unidirectional filters will each be stored in single unified flow-description records. If the 3GPP Gx/Gxx interface specifies a bidirectional filter, then the bidirectional filter may be mapped into two separate flow-direction records: one for uplink and one for downlink. Also, an indication that the flow is bidirectional will be stored in the unified flow-description AVP. The method then proceeds to step 230.

If the SDF input is flow information from an AF request, then the method 200 may proceed to copy the flow information from the AF request directly to unified flow-direction records 220. The method then proceeds to step 230.

If the PCRF provisions PCC, ADC, or QoS rules with flow information, then the method 200 may proceed based upon whether the flow information is unidirectional or bidirectional 225. If the flow information is unidirectional, the method 200 may copy the flow information from the PCC, ADC, or QoS rules directly to unified flow-direction records. If the flow information is bidirectional, the method 200 may map the bidirectional flow information into two separate unified flow-direction records. Also, an indication that the flow is bidirectional will be stored in the unified flow-description AVP. The method then proceeds to step 245.

Step 230 determines if there is a flow match between the AF and UE SDF inputs. If so, then the method 200 may generate combined PCC, QoS, and/or ADC rules for the AF and UE SDF inputs 235. Such rules may combine and use information received from both the AF and UE SDF inputs. If not, then the method 200 may generate separate PCC, QoS and/or ADC for the AF request and for the UE request inputs 240.

Next, the method determines if flow direction is defined on the Gx or Gxx interface to be used to implement the PCC, ADC, or QoS rules 245. Such determination may be determined by the specific version of 3GPP used on the Gx and Gxx interface. Various network nodes may use different versions of the Gx and Gxx interfaces. If flow direction is not defined on the Gx or Gxx interface, the method proceeds to step 255. If flow direction is defined on the Gx or Gxx interface, then the method 200 maps the unified flow-direction information pair along with the stored unified flow direction AVP into a bidirectional flow-description AVP 250. Finally, PCC, ADC, and/or QoS rules may be delivered to the PCEN and/or BBERF 260.

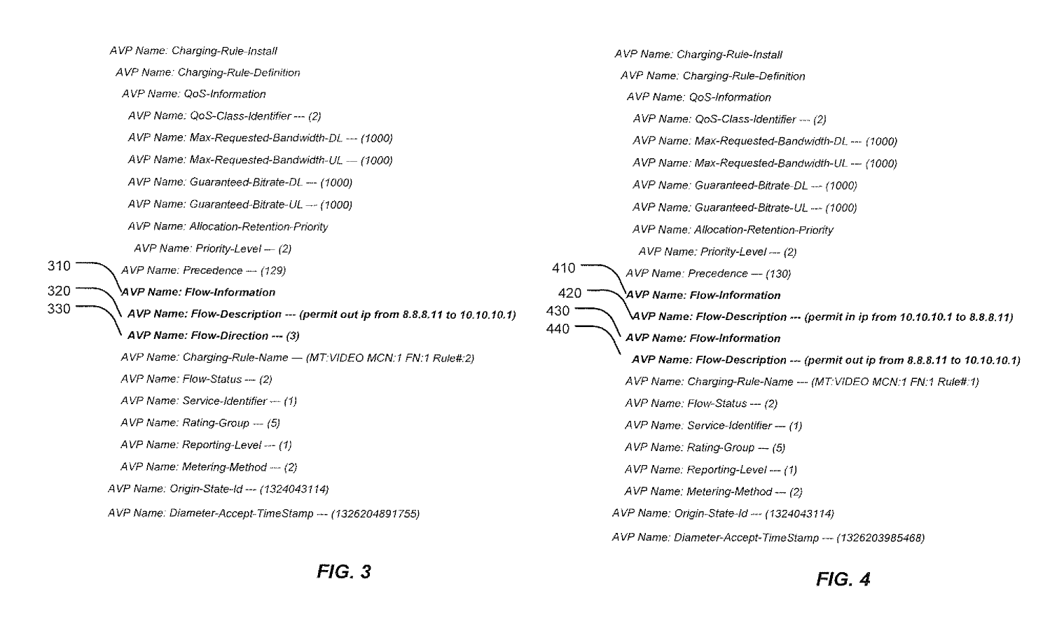

FIG. 3 illustrates a Diameter RAR message on a Gx interface using the 3GPP TS 29.212 version 9.3.0 specification. The Diameter RAR message may include a Flow-Information AVP 310. The Flow-Information AVP 310 may then include: Flow-Description AVP 320 and Flow-Direction AVP 330. The message is from a PCRN that outputs a PCC rule with a bidirectional single flow filter.

FIG. 4 illustrates a Diameter RAR message on a Gx interface using the 3GPP TS 29.212 version 8 specification. The Diameter RAR message may include a first Flow-Information AVP 410. The first Flow-Information AVP 410 may include a first Flow-Description AVP 420. The first Flow-Information AVP 410 may describe a flow in a first direction. The Diameter RAR message may include a second Flow-Information AVP 430. The second Flow-Information AVP 430 may include a second Flow-Description AVP 440. The second Flow-Information AVP 430 may describe a flow in a second direction, hence allowing for the description of a bidirectional flow by using two Flow-Information AVPs. The message is from a PCRN that outputs a PCC rule with separate uplink and downlink flow filters.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a policy and charging rules node (PCRN) device for implementing a PCC procedure with SDF inputs, the method comprising:
receiving a PCC request with a SDF input;
determining if the PCC request is from a user equipment (UE);
mapping flow direction information from the SDF input request into a unified flow-direction record stored in the PCRN;
generating PCC, ADC, and/or QoS rules based upon the unified flow-direction record;
determining if flow direction is defined on an output interface;
mapping the unified flow-direction record into a flow-information AVP associated with the generated PCC, ADC, and/or QoS rules;
delivering the generated PCC, ADC, and/or QoS rules to another node.

2. The method of claim 1, wherein the step of mapping flow direction information includes mapping the SDF input that specifies a bidirectional flow into two unified flow-direction records.

3. The method of claim 1, further comprising:
determining if the PCC request is from a application function (AF);
copying the flow information from the AF request directly to unified flow-direction records.

4. The method of claim 3, further comprising:
determining if there is a flow match between the AF and UE SDF inputs;
if so, then generating PCC, ADC, and/or QoS rules includes generating combined PCC, ADC, and/or QoS rules based upon the AF and UE SDF inputs; and
if not, then generating PCC, ADC, and/or QoS rules includes generating separate PCC, ADC, and/or QoS rules.

5. The method of claim 3, further comprising:
determining if the PCC request is the result of the PCRN provisioning PCC, ADC, and/or QoS rules;
determining if received flow information from the PCRN provisioning is bidirectional:
if so, then mapping flow direction information from the PCRN request into unified flow-direction records stored in the PCRN;
if not, then copying the flow information from the PCRN request directly to unified flow-direction records.

6. The method of claim 1, wherein if the flow direction is not defined on the output interface, then skipping the step of mapping the unified flow-direction record into a flow-information AVP associated with the generated PCC, ADC, and/or QoS rules.

7. A system comprising:
a policy and charging enforcement node;
a policy and charging rules node (PCRN) wherein the is configured to perform the method of claim 1.

8. A method performed by a policy and charging rules node (PCRN) device for implementing a PCC procedure with SDF inputs, the method comprising:
receiving a PCC request with a SDF input;
determining if the PCC request is from a application function (AF);
copying the flow information from the AF request directly to unified flow-direction records;
generating PCC, ADC, and/or QoS rules based upon the unified flow-direction record;
determining if flow direction is defined on an output interface;
mapping the unified flow-direction record into a flow-information AVP associated with the generated PCC, ADC, and/or QoS rules;
delivering the generated PCC, ADC, and/or QoS rules to another node.

9. The method of claim 8, further comprising:
determining if there is a flow match between the AF and UE SDF inputs;
if so, then generating PCC, ADC, and/or QoS rules includes generating combined PCC, ADC, and/or QoS rules based upon the AF and UE SDF inputs; and
if not, then generating PCC, ADC, and/or QoS rules includes generating separate PCC, ADC, and/or QoS rules.

10. The method of claim 8, further comprising:
determining if the PCC request is from a user equipment (UE);
mapping flow direction information from the SDF input request into a unified flow-direction record stored in the PCRN;
determining if the PCC request is the result of the PCRN provisioning PCC, ADC, and/or QoS rules;
determining if received flow information from the PCRN provisioning is bidirectional:
if so, then mapping flow direction information from the PCRN request into unified flow-direction records stored in the PCRN;
if not, then copying the flow information from the PCRN request directly to unified flow-direction records.

11. The method of claim 10, wherein the step of mapping flow direction information includes mapping the SDF input that specifies a bidirectional flow into two unified flow-direction records.

12. The method of claim 8, wherein if the flow direction is not defined on the output interface, then skipping the step of mapping the unified flow-direction record into a flow-information AVP associated with the generated PCC, ADC, and/or QoS rules.

13. A system comprising:
a policy and charging enforcement node;
a policy and charging rules node (PCRN) wherein the is configured to perform the method of claim 8.

14. A method performed by a policy and charging rules node (PCRN) device for implementing a PCC procedure with SDF inputs, the method comprising:
receiving a PCC request with a SDF input;
determining if the PCC request is the result of the PCRN provisioning PCC. ADC, and/or QoS rules;
determining if received flow information from the PORN provisioning is bidirectional:
if so, then mapping flow direction information from the PORN request into unified flow-direction records stored in the PORN; and
if not, then copying the flow information from the PORN request directly to unified flow-direction records;
generating PCC, ADC, and/or QoS rules based upon the unified flow-direction record;
determining if flow direction is defined on an output interface;
mapping the unified flow-direction record into a flow-information AVP associated with the generated PCC. ADC, and/or QoS rules;
delivering the generated PCC, ADC, and/or QoS rules to another node.

15. The method of claim 14, further comprising:
determining if the PCC request is from a application function (AF);
copying the flow information from the AF request directly to unified flow-direction records.

16. The method of claim 14, further comprising:
determining if the PCC request is from a user equipment (UE);
mapping flow direction information from the SDF input request into a unified flow-direction record stored in the PCRN.

17. The method of claim 16, wherein the step of mapping flow direction information includes mapping the SDF input that specifies a bidirectional flow into two unified flow-direction records.

18. The method of claim 16, further comprising:
determining if the PCC request is from a application function (AF);
copying the flow information from the AF request directly to unified flow-direction records.

19. The method of claim 18, further comprising:
determining if there is a flow match between the AF and UE SDF inputs;
if so, then generating PCC, ADC, and/or QoS rules includes generating combined PCC, ADC, and/or QoS rules based upon the AF and UE SDF inputs; and
if not, then generating PCC, ADC, and/or QoS rules includes generating separate PCC, ADC, and/or QoS rules.

20. The method of claim 14, wherein if the flow direction is not defined on the output interface, then skipping the step of mapping the unified flow-direction record into a flow-information AVP associated with the generated PCC, ADC, and/or QoS rules.
